(19) United States
(12) Patent Application Publication
(10) Pub. No.: US 2007/0139338 A1
(43) Pub. Date: Jun. 21, 2007

(54) Liquid crystal display driver

(75) Inventors: Chun-Sheng Lin, Taipei City (TW); Wen-Yu Liao, Yilan County (TW)

Correspondence Address: BIRCH STEWART KOLASCH & BIRCH, PO BOX 747, FALLS CHURCH, VA, 22040-0747, US

(73) Assignee: Sitronix Technology Corp.

(21) Appl. No.: 11/312,604

(22) Filed: Dec. 21, 2005

(51) Int. Cl. G09G 3/36

(52) U.S. Cl. 345/96

(57) ABSTRACT

A liquid crystal display (LCD) driver has the characteristic that using a voltage-switching control circuit to receive the liquid crystal positive voltage and the segment positive voltage generated by the driving voltage generating circuit. The voltage-switching control circuit respectively switches the liquid crystal positive voltage and the liquid crystal negative voltage to input to the common driver in different frame stages such that only one of the liquid crystal positive voltage and the liquid crystal negative voltage exists at the same time. Therefore, for the choice of the semiconductor manufacturing process for the LCD driver, the process with only half of the voltage-resistant can be chosen according to the original design of the circuit, and the supplying for the voltage needed by the segment driver and the common driver is unchanged.

### FIELD OF THE INVENTION

The present invention relates to a technology of LCD, especially to a circuit that automatically switches the liquid crystal positive and negative voltages (+Vlcd and −Vlcd) such that the manufacturing process with only half the voltage-resistant can be chosen.

### BACKGROUND OF THE INVENTION

In the five-level driving method for a Super Twisted Nematic (STN) LCD, five driving voltages are needed to drive the LCD. Regarding the specification for driving an IC by a common High Frequency Amplitude Selection Method (HiFas), the liquid crystal positive voltage +Vlcd is +20V and the liquid crystal negative voltage −Vlcd is −20V such that the semiconductor manufacturing process has to choose the 40V voltage-resistant high voltage process.

FIG. 1 shows the block diagram for a conventional LCD driver that operates according to the five-level driving method. Please refer to FIG. 1, a conventional LCD driver includes a driving voltage generating circuit 11 used to generate five driving voltages. These five driving voltages include the liquid crystal positive voltage +Vlcd, the liquid crystal negative voltage −Vlcd, the segment positive voltage +Vseg, the common electrode voltage Vcom, and the segment negative voltage −Vseg. And a segment driver 12 controlled by a driving polarity signal CON receives the segment positive voltage +Vseg and the segment negative voltage −Vseg to generate a segment-driving signal SEG. A common driver 13 controlled by the driving polarity signal CON receives the liquid crystal positive voltage +Vlcd, the common electrode voltage Vcom, and the liquid crystal negative voltage −Vlcd to generate a common driving signal COM. The voltage-waveform diagram for the segment-driving signal SEG and the common driving signal COM of the driving polarity signal CON is shown in FIG. 2.

For the conventional LCD drivers, it is clear that when operating an LCD (such as STN LCD and CSTN LCD), the display time is divided into the positive frame and the negative frame according to the logic state of the driving polarity signal CON. The logic state of the negative frame may be voltage-low, while the positive frame's is voltage-high (as shown in FIG. 2); or the logic state of the negative frame is voltage-high, while the positive frame's is voltage-low (not shown in the figure). According to the logic state of the driving polarity signal CON shown in FIG. 2, the liquid crystal negative voltage −Vlcd is used during the positive frame while the liquid crystal positive voltage +Vlcd is used during the negative frame. The two voltages have the following relations:
+Vlcd−(−Vseg)=+Vseg−(−Vlcd)
For example:
+Vlcd=20V, −Vlcd=−15V, −Vseg=0V, and Vseg=5V.

Then the semiconductor manufacturing process for the LCD driver has to choose a component which has the voltage-resistant being the voltage difference between the highest voltage +Vlcd and the lowest voltage −Vlcd of the driving voltage generating circuit 11. In detail, it should be considered completing a high-voltage (40V) component of the semiconductor manufacturing process.

However, the chip area needed by a high-voltage component is large. Therefore, the higher the voltage-resistant the lager the component's dimension. The equipment cost for the semiconductor manufacturing process of high-voltage components is higher than that of an ordinary semiconductor manufacturing process. Since the larger the dimension the more material it needs, the cost is increased relatively.

### SUMMARY OF THE INVENTION

Consequently, for solving the abovementioned problems, the present invention provides an LCD driver that has a voltage-switching control circuit. The liquid positive/negative voltage of an LCD appears in the negative frame/positive frame respectively. They will not appear at the same time. In other words, the positive and negative voltages are not necessary to exist at the same time. Therefore, the present invention can switch the liquid positive and negative voltages alternately by using the voltage-switching control circuit, and the supplying for the voltage needed by the segment driver and the common driver is unchanged. Accordingly, on the choice of the semiconductor manufacturing process for the LCD driver, according to the original design of the circuit, the process with only half the voltage-resistant can be chosen if the driver of the present invention is adopted. By way of this, it is not necessary to use high-voltage manufacturing equipments for manufacturing the LCD driver, and the component size can also be reduced such that the manufacturing cost gets down substantially.

The LCD driver of the present invention includes a driving voltage generating circuit, a segment driver, a common driver, and a voltage-switching control circuit. The driving voltage generating circuit generates five driving voltages. These five driving voltages include a liquid crystal positive voltage, a liquid crystal negative voltage, a segment positive voltage, a common electrode voltage Vcom, and a segment negative voltage. The segment driver receives the segment positive voltage and the segment negative voltage to generate a segment-driving signal. The voltage-switching control circuit receives the liquid crystal positive voltage, the segment positive voltage, the segment negative voltage, and the liquid crystal negative voltage. And then the common driver receives the liquid crystal positive voltage and the liquid crystal negative voltage that are respectively output from a first and a second output terminals and the common electrode voltage to generate a common-driving signal.

In the present invention, the voltage-switching control circuit includes a first switch and a second switch. The first switch makes the first output terminal connect to the output terminal of the liquid crystal positive voltage, or to the output terminal of the segment positive voltage. The first output terminal connects to the positive voltage terminal of the common driver. The second switch makes the second output terminal connect to the output terminal of the liquid crystal negative voltage, or to the output terminal of the segment negative voltage. And the second output terminal connects to the negative voltage terminal of the common driver.

More detailed, the present invention utilizes the concept that when operating the LCD, only the liquid crystal negative voltage is used during the positive frame, and only the liquid crystal positive voltage is used during the negative frame. The liquid crystal negative voltage and the liquid crystal positive voltage will not exist at the same time. Consequently, when the display state is the positive frame, the first switch makes the first output terminal connect to the output terminal of the segment positive voltage; and the second switch makes the second output terminal connect to the output terminal of the liquid crystal negative voltage. Hence, during the positive frame, the voltage-switching control circuit conducts the segment positive voltage and the liquid crystal negative voltage to the common driver. The liquid crystal negative voltage is needed by the common driver only during the positive frame.

When the display state is the negative frame, the first switch makes the first output terminal connect to the output terminal of the liquid crystal positive voltage; and the second switch makes the second output terminal connect to the output terminal of the segment negative voltage. Hence, during the negative frame, the voltage-switching control circuit conducts the liquid crystal positive voltage and the segment negative voltage to the common driver. The liquid crystal positive voltage is needed by the common driver only during the negative frame.

As a result, the present invention utilizes the voltage-switching control circuit to switch the liquid crystal positive voltage and the liquid crystal negative voltage respectively to input to the common driver in different frames such that only one of the liquid crystal positive voltage and the liquid crystal negative voltage exists at the same time. Therefore, for the choice of the semiconductor manufacturing process for the LCD driver, the process with only half of the voltage-resistant can be chosen according to the original design of the circuit, and the supplying for the voltage needed by the segment driver and the common driver is unchanged.

### BRIEF DESCRIPTION FOR THE DRAWINGS

FIG. 1 shows the block diagram for a conventional LCD driver that operates according to the five-level driving method.

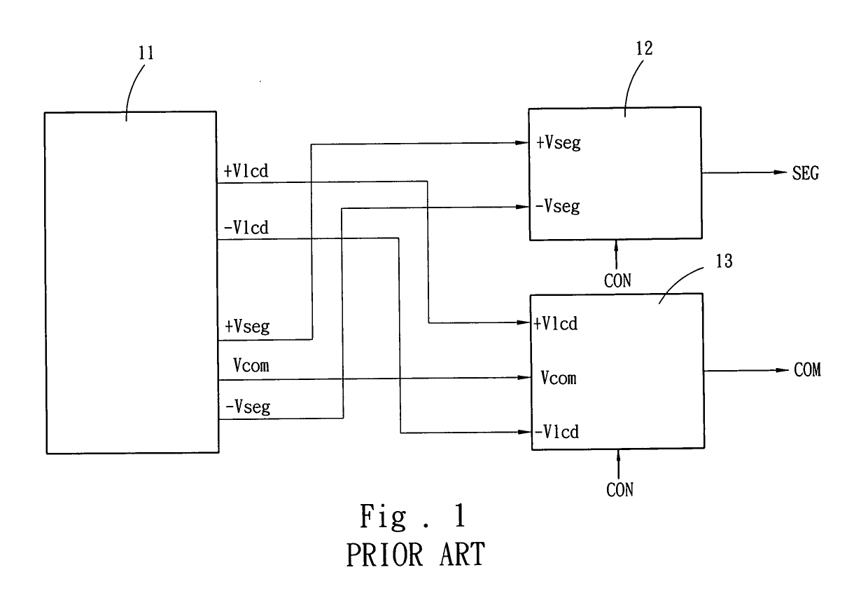

FIG. 2 is the voltage-waveform diagram for the segment-driving signal SEG and the common driving signal COM of the driving polarity signal CON based on the LCD driver shown in FIG. 1.

FIG. 3 shows the block diagram for the LCD driver of the present invention that operates according to the five-level driving method.

FIG. 4 shows the block diagram for the LCD driver of another embodiment example of the present invention.

### DETAILED DESCRIPTION OF THE PREFERRED EMBODIMENTS

The detailed descriptions for content and technology of the present invention accompanying with figures are as follows.

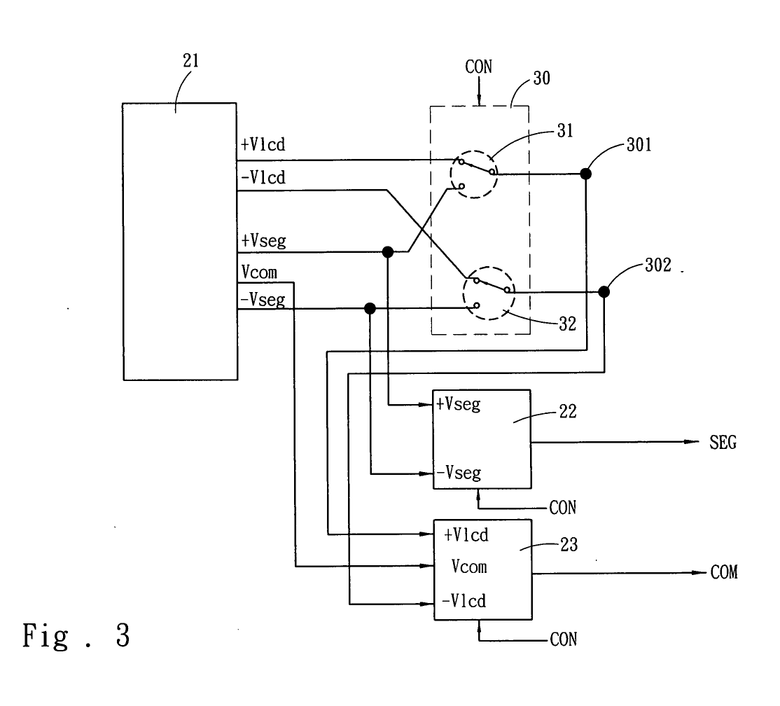

Please refer to FIG. 3, which shows the block diagram for the LCD driver of the present invention that operates according to the five-level driving method. The LCD driver of the present invention includes a driving voltage generating circuit 21 used to generate five driving voltages. These five driving voltages include the liquid crystal positive voltage +Vlcd, the liquid crystal negative voltage −Vlcd, the segment positive voltage +Vseg, the common electrode voltage Vcom, and the segment negative voltage −Vseg. And a segment driver 22 controlled by a driving polarity signal CON receives the segment positive voltage +Vseg and the segment negative voltage −Vseg to generate a segment-driving signal SEG. A voltage-switching control circuit 30 controlled by the driving polarity signal CON receives the liquid crystal positive voltage +Vlcd, the segment positive voltage +Vseg, the segment negative voltage −Vseg, and the liquid crystal negative voltage −Vlcd. A common driver 23 controlled by the driving polarity signal CON receives the liquid crystal positive voltage +Vlcd and the liquid crystal negative voltage −Vlcd that are respectively output by the first output terminal 301 and the second output terminal 302 of the voltage-switching control circuit 30, and the common electrode voltage Vcom to generate a common driving signal COM.

The voltage-switching control circuit 30 includes a first switch 31 and a second switch 32. The first switch 31 responds to the driving polarity signal CON by connecting the first output terminal 301 to the output terminal of the liquid crystal positive voltage +Vlcd, or to the output terminal of the segment positive voltage +Vseg, and the first output terminal 301 also connects to the positive voltage terminal (+Vlcd) of the common driver 23. The second switch 32 responds to the driving polarity signal CON by connecting the second output terminal 302 to the output terminal of the liquid crystal negative voltage −Vlcd, or to the output terminal of the segment negative voltage −Vseg, and the second output terminal 302 also connects to the negative voltage terminal (−Vlcd) of the common driver 23.

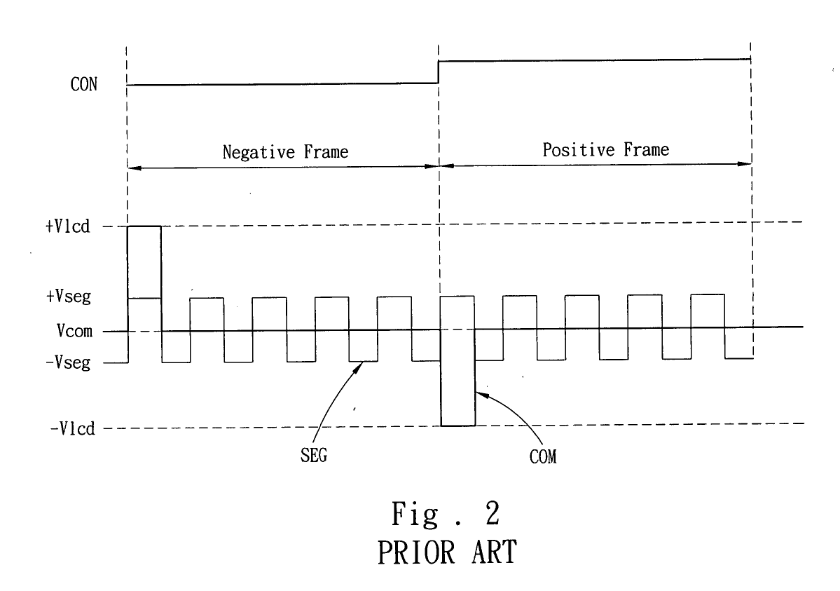

More detailed, the present invention utilizes the concept that when operating an LCD (such as STN LCD and CSTN LCD) the display time is divided into the positive frame and the negative frame according to the logic state of the driving polarity signal CON. The logic state of the negative frame may be voltage-low, while the positive frame's is voltage-high (as shown in FIG. 2); or the logic state of the negative frame is voltage-high, while the positive frame's is voltage-low (not shown in the figure). Only the liquid crystal negative voltage −Vlcd is used during the positive frame, and only the liquid crystal positive voltage +Vlcd is used during the negative frame, the liquid crystal negative voltage −Vlcd and the liquid crystal positive voltage +Vlcd will not exist at the same time. However, the present invention needs to get the same voltage-waveform diagram for the segment-driving signal SEG and the common driving signal COM of a driving polarity signal CON as shown in FIG. 2.

As shown in FIG. 2, when the driving polarity signal CON is in a positive frame, the voltage output of the segment-driving signal SEG and the common driving signal COM need the segment positive voltage +Vseg, the common electrode voltage Vcom, the segment negative voltage −Vseg, and the liquid crystal negative voltage −Vlcd. Therefore, when the display state is in the positive frame, the first switch 31 makes the first output terminal 301 connect to the output terminal of the segment positive voltage +Vseg; and the second switch 32 makes the second output terminal 302 connect to the output terminal of the liquid crystal negative voltage −Vlcd. Accordingly, the segment positive voltage +Vseg and the segment negative voltage −Vseg generated by the driving voltage generating circuit 21 are used for the segment driver 22, and the segment positive voltage +Vseg, the common electrode voltage Vcom, and the liquid crystal negative voltage −Vlcd are used for the common driver 23.

When the driving polarity signal CON is in a negative frame, the voltage output of the segment-driving signal SEG and the common driving signal COM need the segment positive voltage +Vseg, the common electrode voltage Vcom, the segment negative voltage −Vseg, and the liquid crystal positive voltage +Vlcd. Therefore, when the display state is in the negative frame, the first switch 31 makes the first output terminal 301 connect to the output terminal of the liquid crystal positive voltage +Vlcd; and the second switch 32 makes the second output terminal 302 connect to the output terminal of the segment negative voltage −Vseg. Accordingly, the segment positive voltage +Vseg and the segment negative voltage −Vseg generated by the driving voltage generating circuit 21 are used for the segment driver 22, and the liquid crystal positive voltage +Vlcd, the common electrode voltage Vcom, and the segment negative voltage −Vseg are used for the common driver 23. The segment positive voltage +Vseg and the segment negative voltage −Vseg are used for the segment driver 22, the common electrode voltage Vcom and the liquid crystal positive voltage +Vlcd are used for the common driver.

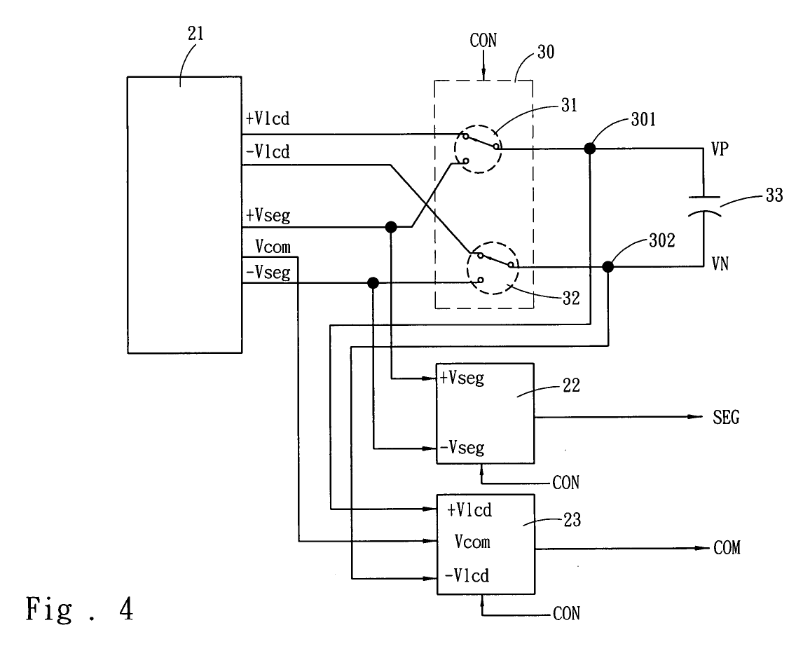

The present invention utilizes the voltage-switching control circuit 30 to switch the liquid crystal positive voltage +Vlcd and the liquid crystal negative voltage −Vlcd respectively such that only one of the liquid crystal positive voltage +Vlcd and the liquid crystal negative voltage −Vlcd exists at the same time. Therefore, for the choice of the semiconductor manufacturing process for the LCD driver, the process with only half of the voltage-resistant (Vlcd-GND) can be chosen according to the original design of the circuit, and the supplying for the voltage needed by the segment driver 22 and the common driver 23 is unchanged. Please refer to FIG. 4, which shows the block diagram for the LCD driver of another embodiment example of the present invention. Furthermore, the LCD driver of the present invention can include a storage capacitor 33. The storage capacitor 33 has a positive-voltage terminal VP and a negative-voltage terminal VN, and the first output terminal 301 and the second output terminal 302 of the voltage-switching control circuit 30 connect to the positive-voltage terminal VP and the negative-voltage terminal VN respectively.

The first output terminal and the second output terminal electrically connect to the positive-voltage terminal and the negative-voltage terminal of a capacitor.

Similarly, the present invention utilizes the concept that when operating the LCD only the liquid crystal negative voltage −Vlcd is used during the positive frame, and only the liquid crystal positive voltage +Vlcd is used during the negative frame, the liquid crystal negative voltage −Vlcd and the liquid crystal positive voltage +Vlcd will not exist at the same time.

The actions for the embodiment are that when the display state is in the positive frame, the first switch 31 makes the first output terminal 301 connect to the output terminal of the segment positive voltage +Vseg; and the second switch 32 makes the second output terminal 302 connect to the output terminal of the liquid crystal negative voltage −Vlcd. Accordingly, the potential of the positive-voltage terminal VP of the storage capacitor 33 is the segment positive voltage +Vseg, and the potential of the negative-voltage terminal VN is the liquid crystal negative voltage −Vlcd. In other words, during the positive frame period, the segment positive voltage +Vseg and the liquid crystal negative voltage −Vlcd generated by the voltage-switching control circuit 30 are input to the positive-voltage terminal and the negative-voltage terminal of the common driver 23 respectively.

When the display state transfers from the positive frame to the negative frame, by way of the control signal the first switch 31 switches away from the output terminal of the segment positive voltage +Vseg; and the second switch 32 switches away from the output terminal of the liquid crystal negative voltage −Vlcd at this time. Then, the second switch 32 switches to connect the output terminal of the segment negative voltage −Vseg; and the first switch 31 switches to connect the output terminal of the liquid crystal positive voltage +Vlcd such that the potential of the positive-voltage terminal VP of the storage capacitor 33 is kept at the level of the liquid crystal positive voltage +Vlcd.

When the display state is in the negative frame, the first switch 31 makes the first output terminal 301 connect to the output terminal of the liquid crystal positive voltage +Vlcd; and the second switch 32 makes the second output terminal 302 connect to the output terminal of the segment negative voltage −Vseg. Accordingly, the potential of the positive-voltage terminal VP of the storage capacitor 33 is the liquid crystal positive voltage +Vlcd, and the potential of the negative-voltage terminal VN is the segment negative voltage −Vseg. In other words, during the negative frame period, the liquid crystal positive voltage +Vlcd and the segment negative voltage −Vseg generated by the voltage-switching control circuit 30 are input to the positive-voltage terminal and the negative-voltage terminal of the common driver 23 respectively.

When the display state transfers from the negative frame to the positive frame, the control signal the first switch 31 switches away from the output terminal of the liquid crystal positive voltage +Vlcd; and the second switch 32 switches away from the output terminal of the segment negative voltage −Vseg at this time. Then, the second switch 32 switches to connect the output terminal of the liquid crystal negative voltage −Vlcd; and the first switch 31 switches to connect the output terminal of the segment positive voltage +Vseg such that the potential of the negative-voltage terminal VN of the storage capacitor 33 is kept at the level of the liquid crystal negative voltage −Vlcd.

Similar to the previous embodiment, the liquid crystal positive and negative voltages (+Vlcd, −Vlcd) appear in the negative frame and the positive frame respectively. They will not exist at the same time. As a result, the driving voltages +Vlcd and −Vlcd generated by the driving voltage generating circuit 21 can do not exist at the same time.

To sum up, the present invention utilizes the voltage-switching control circuit 30 to switch the liquid crystal positive voltage +Vlcd and the liquid crystal negative voltage −Vlcd respectively such that only one of the liquid crystal positive voltage +Vlcd and the liquid crystal negative voltage −Vlcd exists at the same time. Therefore, for the choice of the semiconductor manufacturing process for the LCD driver, the process with only half of the voltage-resistant (Vlcd-GND) can be chosen according to the original design of the circuit, and the supplying for the voltage needed by the segment driver 22 and the common driver 23 is unchanged. Therefore, it is not necessary to use high-voltage manufacturing equipments for manufacturing the LCD driver in the present invention, and the component size can also be reduced such that the manufacturing cost gets down substantially.

However, the above description is only a better practice example for the current invention, which is not used to limit the practice scope of the invention. All equivalent changes and modifications based on the claimed items of the present invention are in the scope of the present invention.

What is claimed is:

1. A liquid crystal display (LCD) driver, comprising:
a driving voltage generating circuit, which is used to generate the liquid crystal positive voltage, the liquid crystal negative voltage, the segment positive voltage, the common electrode voltage, and the segment negative voltage;
a segment driver, which is controlled by a driving polarity signal, receiving the segment positive voltage and the segment negative voltage to generate a segment-driving signal;
a voltage-switching control circuit, which is controlled by the driving polarity signal, receiving the liquid crystal positive voltage and the segment positive voltage, and the segment negative voltage and the liquid crystal negative voltage, and being used to control the liquid crystal positive voltage and the liquid crystal negative voltage to output alternately via the first output terminal and the second output terminal in the positive frame or in the negative frame according to the driving polarity signal; and
a common driver, which is controlled by the driving polarity signal, receiving the liquid crystal positive voltage, and the liquid crystal negative voltage that are provided respectively by the two output terminals of the voltage-switching control circuit, and the common electrode voltage to generate a common driving signal.

2. The LCD driver as claimed in claim 1, wherein the voltage-switching control circuit includes:
a first switch, which makes the first output terminal connect to either one of the output terminal of the liquid crystal positive voltage and the output terminal of the segment positive voltage;
a second switch, which makes the second output terminal connects to one of the output terminal of the liquid crystal negative voltage and the output terminal of the segment negative voltage.

3. The LCD driver as claimed in claim 2, wherein the first output terminal and the second output terminal electrically connect to the positive-voltage terminal and the negative-voltage terminal of a capacitor respectively.

4. The LCD driver as claimed in claim 2, wherein when the driving polarity signal is at logic configuration of the positive frame, the first switch connects the first output terminal to the output terminal of the segment positive voltage; and the second switch connects the second output terminal to the output terminal of the liquid crystal negative voltage.

5. The LCD driver as claimed in claim 2, wherein when the driving polarity signal is at logic configuration of the negative frame, the first switch connects the first output terminal to the output terminal of the liquid crystal positive voltage; and the second switch connects the second output terminal to the output terminal of the segment negative voltage.
